(19) United States
(12) Patent Application Publication
(10) Pub. No.: US 2019/0092481 A1
(43) Pub. Date: Mar. 28, 2019

(54) AIR CONDITIONING PIPE AND PRODUCTION METHOD

(71) Applicant: DIEHL AVIATION LAUPHEIM GMBH, Laupheim/Brd (DE)

(72) Inventors: MARC STEINMAYER, BIBERACH AN DER RISS (DE); ANDRE PFETSCHER, ULM (DE)

(21) Appl. No.: 16/202,183

(22) Filed: Nov. 28, 2018

Related U.S. Application Data
(63) Continuation of application No. PCT/EP2017/000645, filed on Jun. 1, 2017.

(30) Foreign Application Priority Data
Jun. 10, 2016 (DE) 10 2016 007 157.5

(51) Int. Cl. B64D 13/00; F16L 9/12; F16L 9/14; F16L 9/21; F24F 13/02; B32B 1/08; B32B 5/02; B32B 5/26; B29D 23/00

(52) U.S. Cl. CPC B64D 13/00; F16L 9/121; F16L 9/14; F16L 9/21; F24F 13/0227; F24F 13/0263; F24F 2013/242; B32B 1/08; B32B 5/024; B32B 5/26; B32B 5/022; B29D 23/001; F24F 13/0245

(57) ABSTRACT

An air conditioning pipe for carrying a gas in an aircraft includes a wall which is a sandwich component. The wall contains at least one woven fabric which forms a first ply of the wall and at least one fibrous web, made from a material containing glass, which forms a second ply of the wall. A method for producing the air conditioning pipe is also provided.

### CROSS-REFERENCE TO RELATED APPLICATION

This is a continuation application, under 35 U.S.C. § 120, of copending International Application PCT/EP2017/000645, filed Jun. 1, 2017, which designated the United States; this application also claims the priority, under 35 U.S.C. § 119, of German Patent Application DE 10 2016 007 157.5, filed Jun. 10, 2016; the prior applications are herewith incorporated by reference in their entirety.

### BACKGROUND OF THE INVENTION

### Field of the Invention

The invention relates to an air conditioning pipe for an aircraft for carrying a gas. The invention also relates to a method for producing the air conditioning pipe.

Such air conditioning pipes carry air for air conditioning, for example. Air conditioning is carried out for an interior of the aircraft, e.g. the passenger cabin of the aircraft. In accordance with its purpose, the air conditioning pipe is therefore to be mounted in the passenger cabin of the aircraft.

It is desirable for such air conditioning pipes to have a leakage rate which is as low as possible, i.e. as little gas as possible, in the example air, passes through the wall of the air conditioning pipe. At the same time, air conditioning pipes in the aviation sector, in particular, must furthermore be as light as possible and must satisfy fire protection regulations.

### SUMMARY OF THE INVENTION

It is accordingly an object of the invention to provide an air conditioning pipe and a production method, which overcome the hereinafore-mentioned disadvantages of and provide improvements to the heretofore-known devices and methods of this general type.

With the foregoing and other objects in view there is provided, in accordance with the invention, an air conditioning pipe which serves to carry a gas and is intended for mounting in an aircraft in a manner appropriate to its intended use. The air conditioning pipe has a wall. The wall is a sandwich component. The wall contains at least one woven fabric, which forms a first ply or layer of the wall, and at least one fibrous web, made from a material containing glass, which forms a second ply or layer of the wall.

In particular, the woven fabric is a woven glass fabric or a woven glass-carbon fabric (hybrid woven fabric) or a carbon woven fabric.

In particular, the fibrous web contains an oxidic glass. This is preferably an E glass. It preferably contains 53 to 55% by weight of SiO₂ and 14 to 15% by weight of Al₂O₃. The glass is temperature-stable up to 1000° C. In particular, the fibrous web has a uniform fiber distribution.

The wall delimits the air conditioning pipe with respect to an external space. The external space is the space which surrounds the air conditioning pipe. The gas is carried in the internal space surrounded by the wall.

The fibrous web results in a reduction in the microporosity of the fiber composite including the first and the second ply. This serves to improve the leaktightness, in particular airtightness, of the wall and hence of the air conditioning pipe and thus leads to a lowering of the leakage rate across the air conditioning pipe. The leakage rate describes how much gas penetrates the wall per unit time.

The wall can contain further plies including fibrous webs, woven fabrics or other layers.

In a preferred embodiment of the invention, the fibrous web or one of the fibrous webs forms a covering ply facing the internal space. On the air conditioning pipe, the fibrous web is therefore the innermost ply, which is surrounded at most by resin of a prepreg, paint or applications, for example. The fibrous web or a fibrous web material results in an improvement of the surface of the air conditioning pipe since a fibrous web as a covering ply produces a smoother component surface on the air conditioning pipe. Overall, this results in a lower leakage rate of the pipe.

In another preferred embodiment, the wall contains a further woven fabric, which forms a third ply or layer of the wall. The fibrous web of the second ply is disposed between the two woven fabrics of the first and third ply. In particular, there are only the three plies mentioned and no further plies in the air conditioning pipe or the wall. Placing a fibrous web between two woven fabrics in the sandwich component results in a sandwich structure which is more stable overall and which, thanks to the fibrous web, is also impermeable to the passage of gas.

In a further preferred embodiment, at least one of the woven fabrics is a woven fabric of a prepreg (pre-impregnated fibers, woven fabric, impregnated or soaked with resin). The woven fabric is therefore made available or processed as a prepreg for the sandwich composite. A large selection of prepregs is commercially available, and therefore the air conditioning pipe is easy to produce in this respect. In particular, all of the woven fabrics are those including respective prepregs. According to this embodiment, there is integration of fibrous web or fibrous web into a prepreg composite to improve the leakage properties of the air conditioning pipe. Through the introduction of a fibrous semifinished product—in particular a dry fibrous semifinished product—into the prepreg composite, the required leaktightness of the air conditioning pipe, in particular in the form of air carrying components, is achieved and (especially in the case of fibrous web as a covering ply) the surface of the wall is significantly improved.

In an added preferred embodiment, the fibrous web has a basis weight of 20 grams per square meter to 70 grams per square meter, in particular a basis weight of 30 grams per square meter to 50 grams per square meter. According to the invention, the result is the use of fibrous web materials, in particular dry fibrous web materials, with a low area density of 30 to 50 grams per square meter. These area weights have proven to be a good compromise between the weight of the fibrous web or of the air conditioning pipe and the achievable reduction in the leakage rate, especially for aeronautical applications.

In an additional preferred embodiment, the air conditioning pipe is an air conditioning pipe for carrying air as a gas. According to this embodiment, an air-carrying air conditioning pipe with improved airtightness is therefore obtained.

In yet another preferred embodiment, at least one of the fibrous webs has a thickness of 0.1 to 0.8 millimeters, in particular 0.3 to 0.5 millimeters.

In particular, at least one of the fibrous webs has a binder content of 3 percent to 10 percent, in particular 5 percent. The binder serves to hold the web fibers together during the production of the fibrous web.

With the objects of the invention in view, there is also provided a method which is used to produce an air conditioning pipe according to the invention. The method and at least some of the embodiments thereof as well as the respective advantages have already been explained in summary in connection with the air conditioning pipe according to the invention.

In the method, at least one of the woven fabrics, which forms the first ply of the wall, and at least one of the fibrous webs, which forms the second ply of the wall, are made as a sandwich component of the wall. It is particularly simple and economical to produce the air conditioning pipe as a sandwich component.

In a preferred embodiment, at least one of the woven fabrics is supplied as or in the form of or as part of a prepreg. One of the fibrous webs is consolidated with the prepreg to form an assembly. In particular, the fibrous web can also be supplied as a prepreg. This means that the fibrous web has been soaked with a resin, preferably with the same resin as the woven fabric. The wall or the air conditioning pipe is made into the air conditioning pipe using the assembly—in particular together with further plies. “Consolidation” should be understood to mean the appropriate adhesion or adhesive bonding of the fibrous web to the resin or the sticky surface of the prepreg. After production of the prepreg, the fibrous web is thus applied to the prepreg. Additional resin or other auxiliaries are not necessary for this purpose since the prepreg itself contains enough resin or has a sticky surface, to which the fibrous web adheres.

The consolidation of the fibrous web with a prepreg makes the handling of the fibrous web in the production process for the air conditioning pipe particularly simple since it no longer has to be handled separately.

In another preferred embodiment, the fibrous web is supplied as a dry fibrous semifinished product and consolidated into the assembly. The handling of a dry fibrous semifinished product is particularly easy during consolidation.

In a further preferred embodiment, the assembly is consolidated by rolling up the prepreg together with the fibrous web. The process of rolling up results in a contact pressure or pressing force, through the use of which the fibrous web is pressed onto the prepreg, with the result that it adheres particularly well to the excess resin of the prepreg or the sticky surface of the prepreg.

In a concomitant preferred embodiment, the assembly, on one hand, and at least one further ply of the wall of the air conditioning pipe, on the other hand, are laid in separate work steps in a mold before the structure laid in the mold is made into the wall or the air conditioning pipe in the mold. In principle, therefore the production of the air conditioning pipe proceeds in the same way as for identical air conditioning pipes without an inserted fibrous web ply, in which the woven fabric alone is inserted as a prepreg. Since the fibrous web is inserted as an assembly with a prepreg, this represents the same work step as that of inserting a prepreg without a fibrous web. Production processes for existing air conditioning pipes without a fibrous web therefore need only minimal modification or none at all in order to produce air conditioning pipes according to the invention as well.

The invention is based on the following considerations and insights, wherein embodiments of the invention, including combinations of the abovementioned embodiments, possibly also embodiments which have not previously been mentioned, are summarized as follows:

The aim of the invention is to improve the leakage or leakage properties of air conditioning pipes. An improvement in the airtightness or a reduction in the leakage rate of an air conditioning pipe can be achieved by brushing sealing coat on the component surface, i.e. the surface of the air conditioning pipe. The invention resides, in particular, in the use of a fibrous web, in particular a dry fibrous web, as a microsandwich in air-carrying components. According to the invention, use is made particularly of nonwoven fibrous webs. Through the use of the invention, a reduction in the expenditure of work is achieved, in particular the sealing coat and the application thereof are eliminated. Components according to the invention have a higher stability for virtually the same weight. The fibrous web is, in particular, a dry fibrous web, i.e. one which does not involve the application of resin. According to the invention, it is possible, especially in the aeronautical sector, to modify an already existing or known air conditioning pipe in accordance with the invention. In addition, therefore, a fibrous web is introduced during the production of the air conditioning pipe. Since the fibrous web per se is a nonflammable material, the fire load in the air conditioning pipe and thus in the aircraft is thereby altered only slightly or not at all. Approval of an air conditioning pipe modified in this way for aviation purposes is therefore a particularly easy and low-cost possibility.

According to the invention, a dry fibrous web without resin, in particular, is consolidated with a prepreg, after the production of the latter, by rolling up without the use of additional resin. According to the invention, leakage optimization of air-carrying components is achieved.

Other features which are considered as characteristic for the invention are set forth in the appended claims.

Although the invention is illustrated and described herein as embodied in an air conditioning pipe and a production method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an air conditioning pipe according to the invention;

FIG. 2 is an elevational view of a wall of an air conditioning pipe according to the invention during the production thereof; and

FIG. 3 is an elevational view showing the laying of components of the air conditioning pipe in a mold during manufacture.

### DETAILED DESCRIPTION OF THE INVENTION

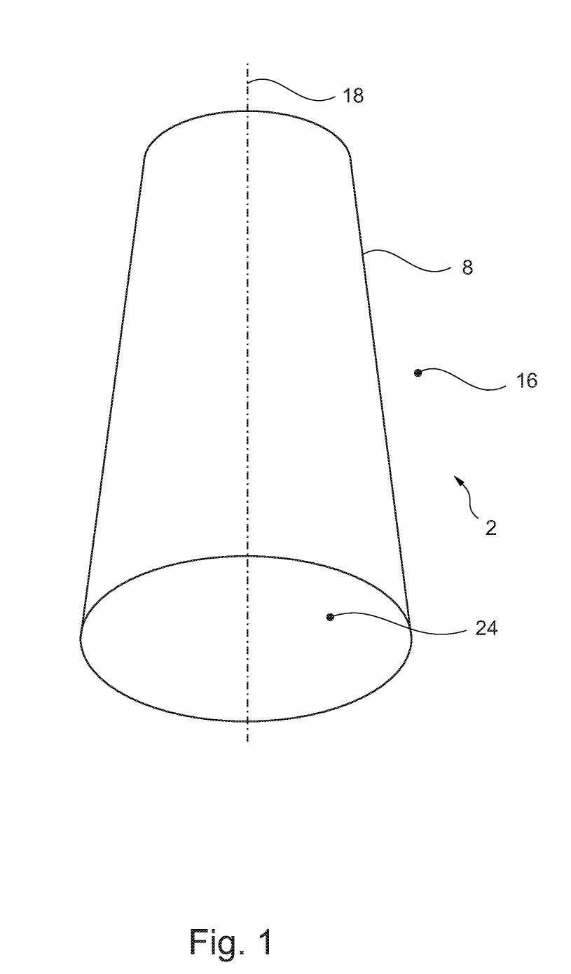

Referring now to the figures of the drawings in detail and first, particularly, to FIG. 1 thereof, there is seen a finished air conditioning pipe 2. The air conditioning pipe has a wall 8. The wall 8 delimits the air conditioning pipe with respect to an external space 16. The air conditioning pipe is therefore surrounded by the external space 16. The air conditioning pipe extends along a central longitudinal axis 18. The wall 8 surrounds an internal space 24 of the air conditioning pipe. The internal space 24 is used to carry a gas (not shown), in this case air.

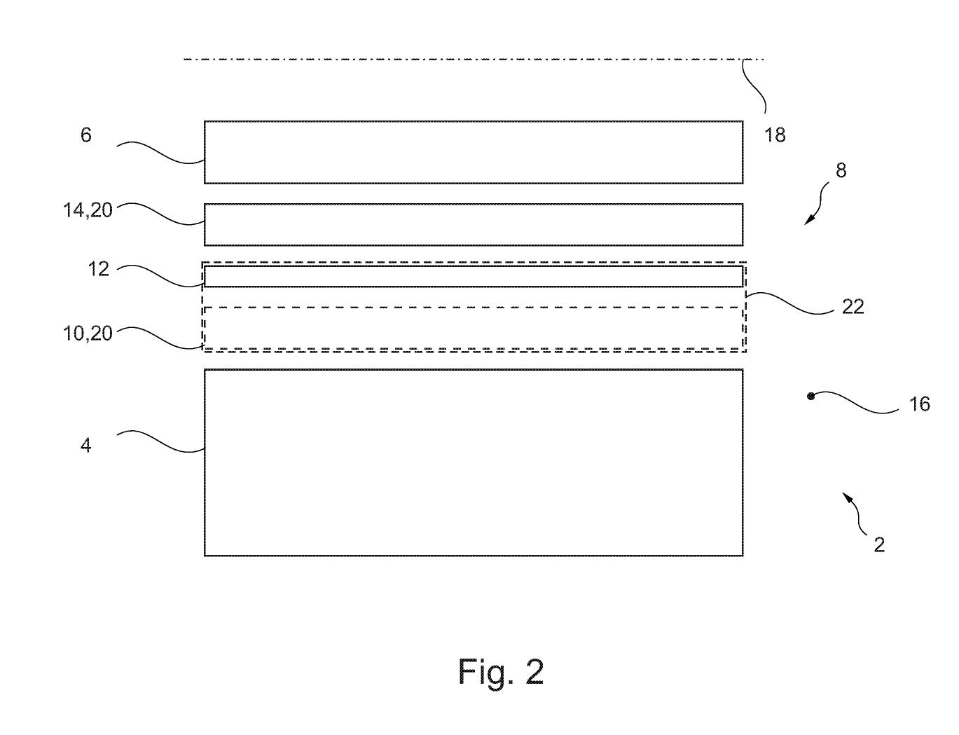

FIG. 2 diagrammatically shows a segment of the air conditioning pipe 2 or the wall 8 thereof during its production, between a metallic mold 4 and a plunger 6. In this case, the central longitudinal axis 18 is indicated diagrammatically. The wall 8 is a sandwich component. The wall 8 contains a woven fabric 10 which forms a first ply or layer of the wall 8, a fibrous web, fleece or mat 12 which is formed from a glass-containing material and which forms a second ply or layer of the wall 8, and a woven fabric 14 which forms a third ply or layer of the wall 8.

Thus, the fibrous web 12 is disposed between the two woven fabrics 10, 14. In the example, the woven fabrics 10, 14 are prefabricated as prepregs, i.e. they are impregnated or soaked with a resin.

In order to produce the air conditioning pipe 2 or the wall 8, the components are joined together between the mold 4 and the plunger 6 by pressing the plunger 6 in the direction of the mold 4.

The woven fabrics 10, 14 are each supplied in the form of a prepreg 20. In an alternative embodiment, the woven fabric 10 and the fibrous web 12 are consolidated into an assembly 22 before being inserted between the mold 4 and the plunger 6. The assembly is indicated in FIG. 1 by a dashed box. During consolidation, the fibrous web 12 is applied to the prepreg 20 and is held on the prepreg by the excess resin or the adhesive surface of the prepreg 20. The assembly 22 and the remaining woven fabric 14, which is likewise supplied as a prepreg 20, are then made into the air conditioning pipe 2 or the wall 8. Consolidation to yield the assembly 22 takes place outside the configuration including the mold 4 and the plunger 6 and before insertion between these elements.

The fibrous web 12 is supplied as a dry fibrous semifinished product or, like the woven fabrics 10, 14, as a prepreg for consolidation into the assembly 22. In the example (not shown), the assembly 22 was consolidated by rolling up the prepreg 20 together with the fibrous web 12 before introduction into or laying onto the mold 4. The assembly 22, on one hand, and the further ply in the form of the woven fabric 14 are laid in the mold 4 in separate work steps before the structure laid in the mold 4, in this case therefore the assembly 22 and the woven fabric 14, are made into the air conditioning pipe 2 in the mold 4.

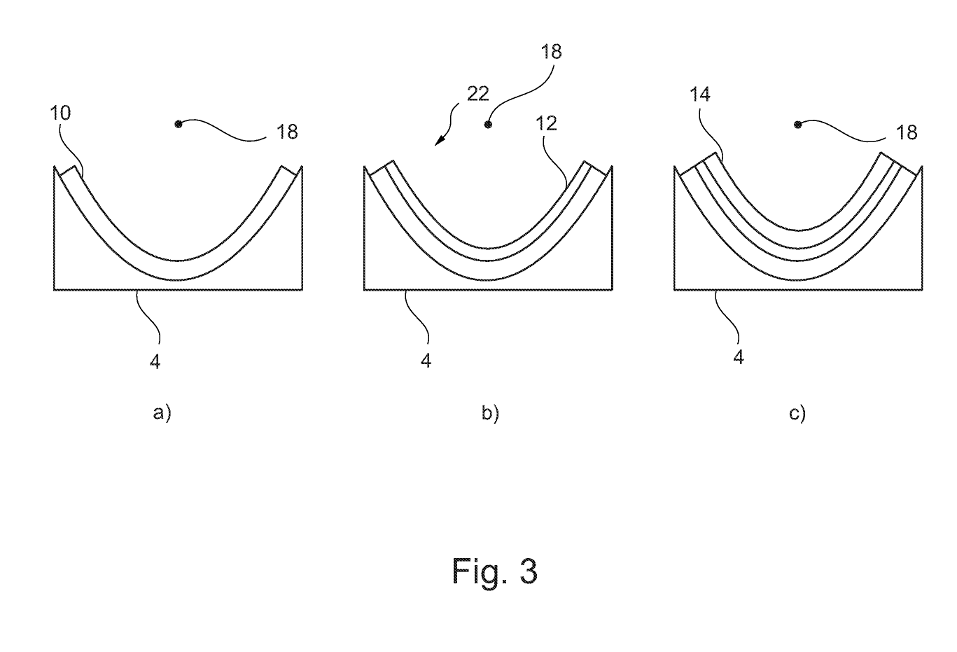

FIG. 3 shows successive steps a), b) and c) in the method for producing the air conditioning pipe 2. The illustration is diagrammatic and shows only a portion of the mold 4 and of the air conditioning pipe 2 or the components thereof. Once again, the central longitudinal axis 18 is indicated. The plunger 6 has been omitted for the sake of clarity.

Initially, as shown in the first step a) of FIG. 2, the woven fabric 10 is laid in the mold 4. In the second step b) shown in FIG. 2, the fibrous web 12 is laid on woven fabric 10.

In an alternative embodiment, the step shown in FIG. 2a) is omitted, namely when woven fabric 10 and the fibrous web 12 have already been consolidated into an assembly 22. FIG. 2b) then shows the first method step, in which the assembly 22 is laid in the mold 4.

According to step c) of FIG. 2, a further ply of the wall 8, namely the woven fabric 14, is then laid on the fibrous web 12 or the assembly 22.

The wall 8 or the air conditioning pipe is then produced as described above by joining the components laid in the mold 4.

The following is a summary list of reference numerals and the corresponding structure used in the above description of the invention:
2 air conditioning pipe
4 mold
6 plunger
8 wall
10 woven fabric
12 fibrous web
14 woven fabric
16 external space
18 central longitudinal axis
20 prepreg
22 assembly
24 internal space

1. An air conditioning pipe for carrying a gas in an aircraft, the air conditioning pipe comprising:
a gas-carrying air conditioning pipe wall being a sandwich component containing:
at least one woven fabric forming a first ply of said wall, and at least one fibrous web made of a material containing glass and forming a second ply of said wall;
said at least one woven fabric including at least one woven fabric of a prepreg; and
said at least one fibrous web containing a resin soaking said at least one fibrous web.

2. The air conditioning pipe according to claim 1, wherein said at least one fibrous web includes a fibrous web forming a covering ply facing an internal space.

3. The air conditioning pipe according to claim 1, wherein:
said wall contains a further woven fabric forming a third ply of said wall; and
said at least one fibrous web of said second ply is disposed between said at least one woven fabric of said first ply and said woven fabric of said third ply.

4. The air conditioning pipe according to claim 1, wherein said at least one fibrous web has a basis weight of 20 g/m² to 70 g/m².

5. The air conditioning pipe according to claim 1, wherein the air conditioning pipe is configured for carrying air as the gas.

6. The air conditioning pipe according to claim 1, wherein said at least one fibrous web includes at least one fibrous web having a thickness of 0.1 to 0.8 millimeters.

7. The air conditioning pipe according to claim 1, wherein said at least one fibrous web includes at least one fibrous web having a binder content of 3 to 10 percent.

8. A method for producing an air conditioning pipe for carrying a gas in an aircraft, the method comprising the following steps:
forming a gas-carrying air conditioning pipe wall containing a sandwich component including:
at least one woven fabric forming a first ply of the wall, and
at least one fibrous web being soaked with a resin, being made from a material containing glass and forming a second ply of the wall.

9. The method according to claim 8, which further comprises:
supplying the at least one woven fabric as a prepreg;
consolidating the at least one fibrous web with the prepreg to form an assembly; and
producing the wall by using the assembly.

10. The method according to claim 9, which further comprises carrying out the step of consolidating the assembly by rolling up the prepreg together with the fibrous web.

11. The method according to claim 9, which further comprises:
laying the assembly and at least one further ply of the wall in a mold in separate work steps to form a structure; and
then making the structure laid in the mold into the wall in the mold.
